(19) United States
(12) Patent Application Publication
(10) Pub. No.: US 2008/0092046 A1
(43) Pub. Date: Apr. 17, 2008

(54) PLAYLIST MANAGEMENT METHOD

(75) Inventor: Dong Hwan BAE, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/865,560

(22) Filed: Oct. 1, 2007

(30) Foreign Application Priority Data
Oct. 11, 2006 (KR) 2006-0099060

(51) Int. Cl. G06F 3/048

(52) U.S. Cl. 715/716

(57) ABSTRACT

A playlist management method for a mobile terminal is provided for editing a playlist in association with a currently playing multimedia file without stopping playback of the multimedia file. The playlist management method includes playing a multimedia file and editing a playlist in association with the multimedia file during the playback of the multimedia file. The playlist management method enables the user to register a music file to a playlist together with a preference level, thereby improving playlist manageability and user convenience.

### PRIORITY

This application claims priority under 35 U.S.C. 119(a) to an application entitled “PLAYLIST MANAGEMENT METHOD” filed in the Korean Intellectual Property Office on Oct. 11, 2006 and assigned Ser. No. 2006-0099060, the contents of which are incorporated herein by reference.

### BACKGROUND OF THE INVENTION

1. Field of the Invention

The present invention relates to a mobile terminal and, in particular, to a playlist management method for a mobile terminal that enables editing a playlist in association with a currently playing multimedia file without stopping playback of the multimedia file.

2. Description of the Related Art

Recently, mobile terminals such as cellular phones are equipped with music and video players. Such a mobile terminal enables creating playlists and managing multimedia files with the playlists. When multimedia files are downloaded from a personal computer or the Internet, however, the downloaded multimedia files are stored within the mobile terminal in a random order.

Although a random playback function, i.e., a shuffle function, is provided, most of multimedia playback applications allow the playlists to be created with particular desired musical atmospheres and maintained without constant user interaction and allow creating playlists by specific attribute of the music such as genre.

In order to create such playlists, however, the user should know about the contents of the multimedia file, and the playlist creation is a cumbersome and tedious process. Also, when a user decides to add a music file to a specific playlist while listening to the music file, the user should stop playing the multimedia file, register the music file to the playlist, and then replay the music file within the playlist, resulting in user inconvenience.

With the continuously increasing storage capacity of mobile terminals, playlist management with many multimedia files is becoming a troublesome issue.

### SUMMARY OF THE INVENTION

The present invention has been made in an effort to solve the above problems, and provides a playlist management method that enables a user to assign a preference level of a music file and to register the music file to a playlist while the music file is played.

Also, the present invention provides a playlist management method that is capable of playing music files belonged to at least one of the playlist and the preference level set by a user.

In accordance with an aspect of the present invention, the above and other objects are accomplished by a playlist management method for a mobile terminal. The playlist management method includes playing a multimedia file and editing a playlist in association with the multimedia file during the playback of the multimedia file.

Preferably, editing a playlist includes assigning a preference level to the multimedia file.

Preferably, editing a playlist includes presenting a plurality of icons; selecting one of the icons for representing the playlist; and registering the selected icon as a playlist icon.

Preferably, editing a playlist includes creating a playlist.

Preferably, creating a playlist includes assigning an icon to the playlist.

Preferably, the preference level is represented by a number of icons that symbolize the playlist.

Preferably, editing a playlist includes determining a play order of files in the playlist in accordance with the preference levels of the files.

Preferably, the playlist management method further includes storing the file together with information on the playlist and the preference level.

Preferably, the playlist is represented by a playlist icon.

Preferably, the playlist management method further includes displaying the playlist screen on which a plurality playlists are selectively presented; selecting one of the playlists; selecting a preference level with which files are to be played; and playing the files assigned the preference level in the playlist.

Preferably, the playlist management method further includes selecting a preference level with which files are to be deleted and deleting the files assigned the preference level in the playlist.

### BRIEF DESCRIPTION OF THE DRAWINGS

The above and other objects, features and advantages of the present invention will become more apparent from the following detailed description taken in conjunction with the accompanying drawings, in which:

FIG. 1 is a block diagram illustrating a configuration of a mobile terminal employing a playlist management method according to the present invention;

FIG. 2 is a flowchart illustrating an ongoing file registration procedure of a playlist management method according to an exemplary embodiment of the present invention;

FIGS. 3 to 6 are screen images illustrating processes of the ongoing file registration procedure of FIG. 2;

FIG. 7 is a flowchart illustrating a playlist creation procedure of a playlist management method according to an exemplary embodiment of the present invention;

FIG. 8 is a screen image illustrating a playlist icon setting screen associated with the playlist creation procedure of FIG. 7;

FIG. 9 is a flowchart illustrating a playlist-based file playback procedure of a playlist management method according an exemplary embodiment of the present invention;

FIG. 10 is a screen image illustrating a playlist screen associated with the playlist-based file playback procedure of FIG. 9; and

FIG. 11 is a flowchart illustrating a playlist editing procedure of a playlist management method according to an exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

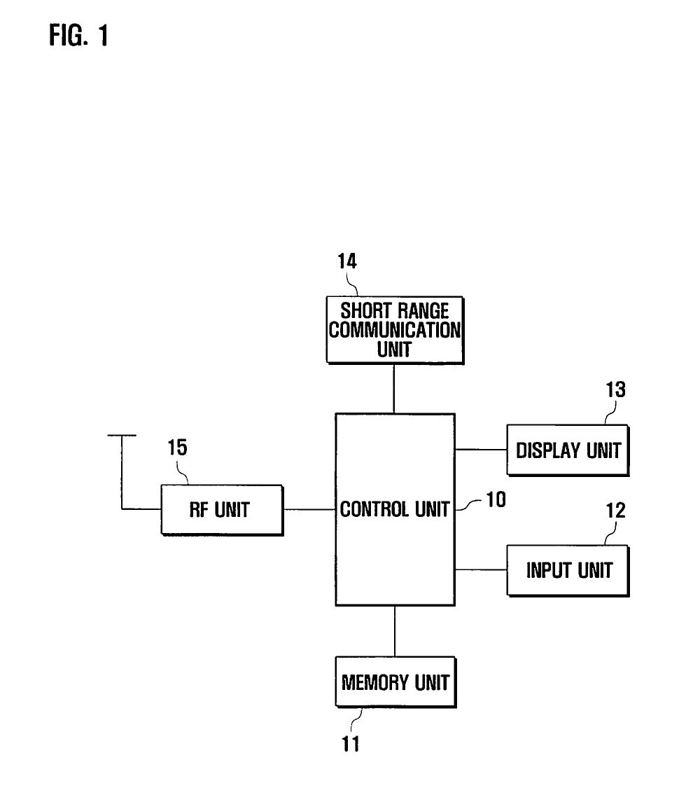

FIG. 1 is a block diagram illustrating a configuration of a mobile terminal employing a playlist management method according to the present invention. In the following description, it is assumed that the mobile terminal is equipped with a multimedia module that can play multimedia files such as music files and motion picture files.

Referring to FIG. 1, the mobile terminal includes a control unit 10, a memory unit 11, an input unit 12, a display unit 13, a short-range communication unit 14, and a Radio Frequency (RF) unit 15.

The short-range communication unit 14 can be implemented with at least one of a Universal Serial Bus (USB) and Bluetooth® interfaces. Through the short-range communication 14, the mobile terminal can exchange data with an external device and download multimedia files from Internet.

The RF unit 15 is responsible for processing radio signals for cellular communication. The input unit 12 allows inputting user data and commands for operating the mobile terminal. The display unit 12 is implemented with a display panel such as Liquid Crystal Display (LCD) for displaying information on input by the user and operation status of the mobile terminal. The control unit 10 controls the cooperation of the internal elements of the mobile terminal.

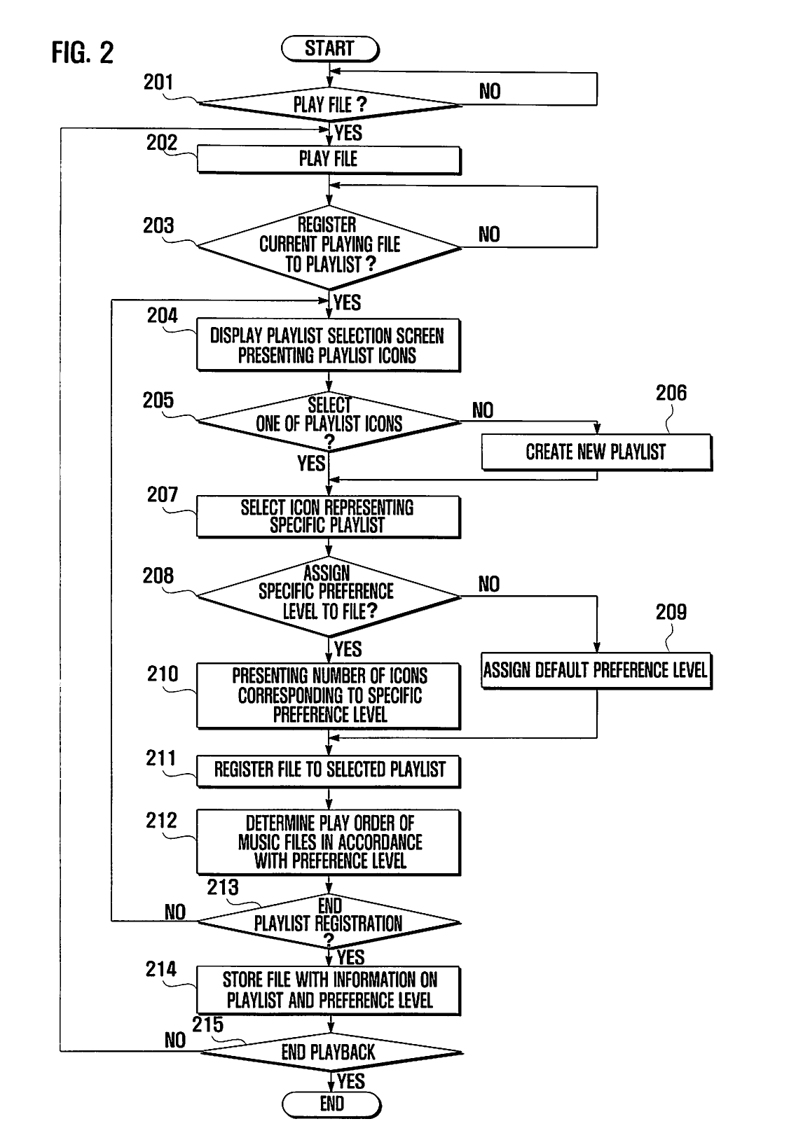

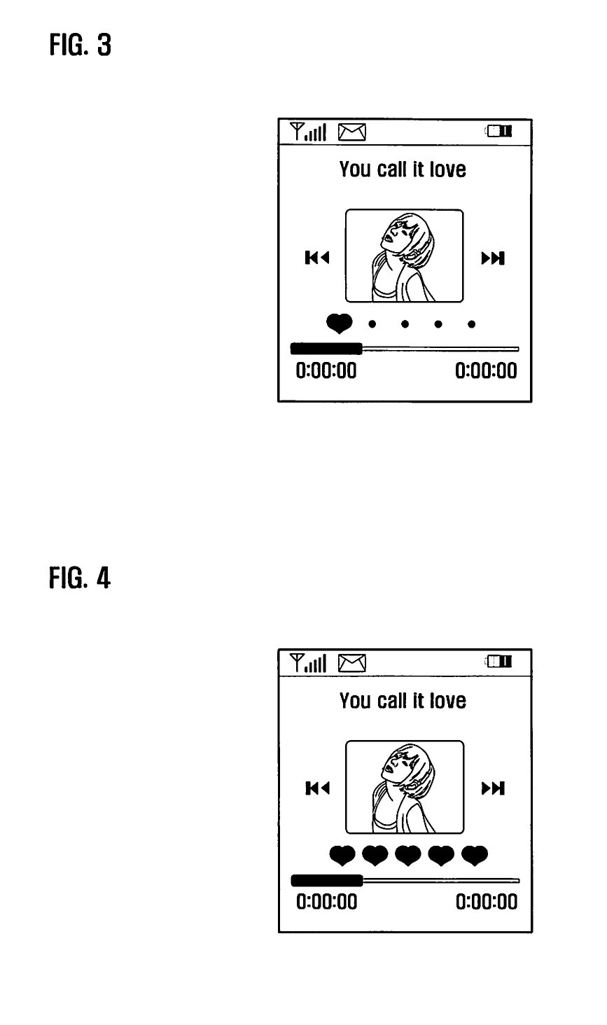

FIG. 2 is a flowchart illustrating an ongoing file registration procedure of a playlist management method according to an exemplary embodiment of the present invention, and FIGS. 3 to 6 are screen images illustrating processes of the ongoing file registration procedure of FIG. 2.

Referring to FIGS. 2 to 6, the mobile terminal determines whether a playback command input for playing a specific file is detected, in step S201. If a playback command is detected, the mobile terminal plays the file, in step S202. For example, a music file entitled “You Call It Love” is selected and played with a playback screen as shown in FIG. 3. While the music file is played, the mobile terminal determines whether a playlist registration command is input, in step S203.

If a playlist registration command is input, the mobile terminal controls to display a playlist selection screen, which allows selecting an icon, in step S204. In FIG. 3, a heart-shaped icon is displayed as an example. The icon is selected among a plurality of icons representing available playlists by manipulating a jog provided in the input unit 12, i.e., one of a plurality of playlists is selected on the playlist selection screen by pushing the jog of the input unit 12 up and down.

Next, the mobile terminal determines whether a playlist selection command or a new playlist generation command is input while an icon is presented on the playlist selection screen, in step S205. If a new playlist generation command is input, the mobile terminal allows the user to generate a new playlist, in step S206.

If a playlist selection command is input, the mobile terminal activates the selected playlist and displays a preference level registration screen such that the user can select a preference level of the file, in step S207.

While the preference level registration screen is displayed, the mobile terminal determines whether a level selection command is input, in step S208.

If a level selection command is input, the mobile terminal determines a number of the icons to be displayed according to the level selection command, in step S210. In this embodiment, the preference level can be adjusted by manipulating a left and right buttons of the jog. In this embodiment, a preference level is represented by a number of the icons, and FIG. 4 shows an example of a preference level registration screen on which preference level 5 is selected of the music file.

That is, the music file “You Call It Love” is registered to a playlist represented by a heart icon with the preference level 5.

If no level selection command is input, the mobile terminal assigns a default preference level to the music file, in step S209.

After the playlist and the preference level for the music file are determined, the mobile terminal registers the music file to the selected playlist with the selected preference level, in step S211, and determines a play order of music files registered to the playlist in accordance with the preference level, in step S212. A music file can be registered to more than one playlist.

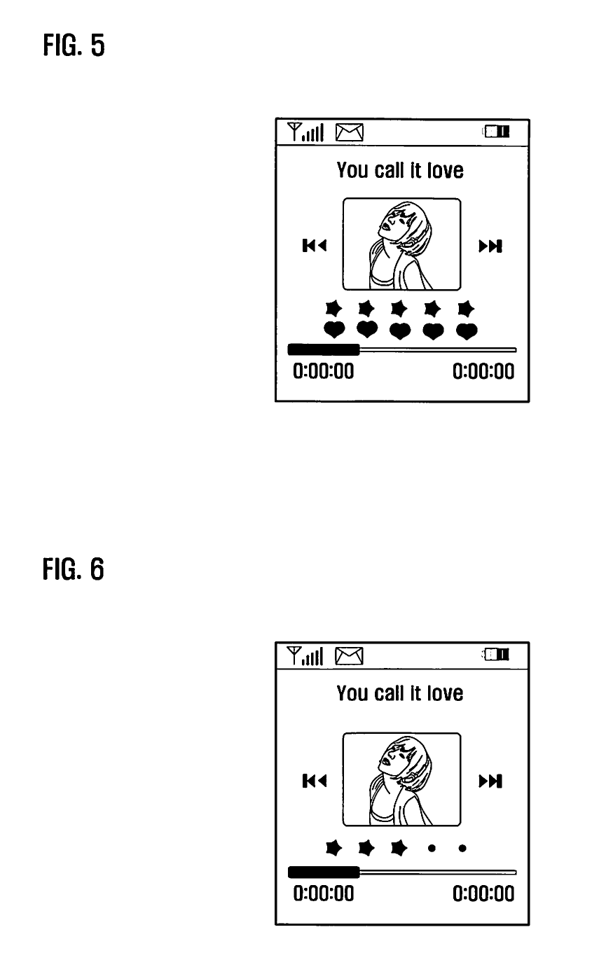

Next, the mobile terminal determines whether a playlist registration end command is input, in step S213. If a playlist registration end command is not input, the mobile terminal repeats step S204, allowing the user to register the music file ‘You call in love’ to another playlist. In this embodiment, it is assumed that another playlist is represented by a star-shaped icon as shown in FIG. 5, and the preference level of the music file in the playlist is level 3, i.e. 3 stars, as shown in FIG. 6. The music file is registered to the playlist represented by the star icon with the preference level 3. In this manner, the music file ‘You Call It Love’ is registered to the heart playlist and the star playlist with different preference levels.

If a playlist registration end command is input, the mobile terminal stores the music file ‘You Call It Love’ in association with the playlists and the preference level in the playlists, in step S214. When a music file is copied or moved to another folder or device, the playlist data and the preference levels of the music file are copied and moved to the other folder or device with the music file itself.

Since the registration procedure is processed during the playback of the music file, the mobile terminal determines whether a playback end command is input, in step S215. If a playback end command is input, the mobile terminal ends the playback of the music file.

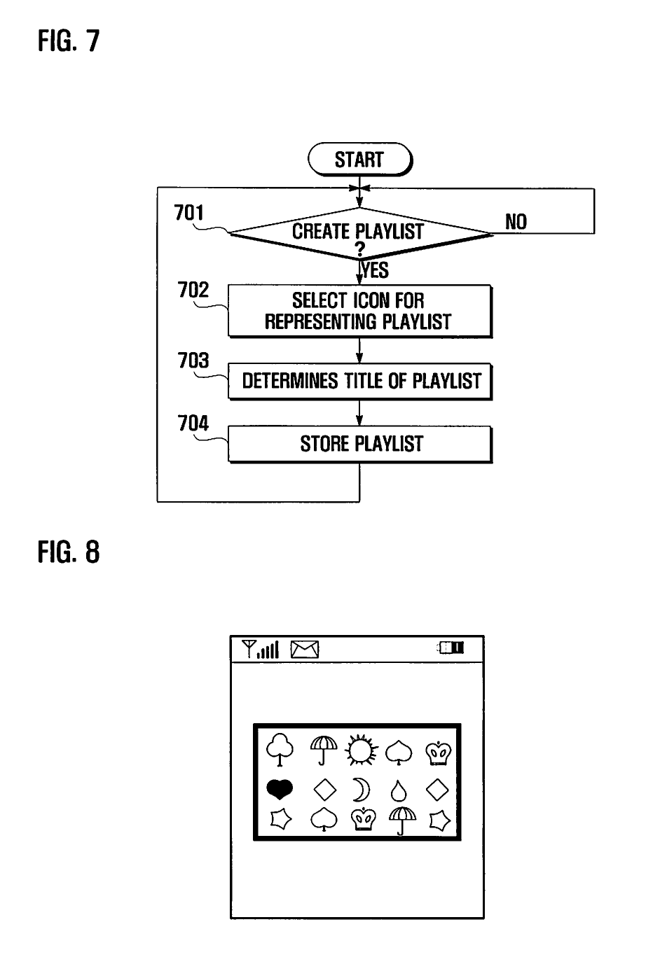

FIG. 7 is a flowchart illustrating a playlist creation procedure of a playlist management method according to an exemplary embodiment of the present invention, and FIG. 8 is a screen image illustrating a playlist icon-setting screen associated with the playlist creation procedure of FIG. 7.

Referring to FIG. 7, the mobile terminal provides a playlist creation procedure for creating at least one playlist. In the playlist creation procedure, the mobile terminal determines whether a playback creation command is input, in step S701. If a playback creation command is input, the mobile terminal displays a playlist icon screen presenting a plurality of icons that can be selected for a playlist (see FIG. 8). The icons can be downloaded from Internet and added to the playlist icon screen. The mobile terminal determines an icon representing a playlist according to a user selection, in step S702. After an icon is selected, the mobile terminal provides a text box on the screen for receiving a text input by the user and determines the title of the playlist with the text, in step S703. For example, if a text ‘lovely’ is input through the text box, the mobile terminal assigns a title ‘lovely’ to the playlist. Consequently, the newly created playlist is stored with the title input by the user, in step S704. The playlist creation procedure can be repeated for creating a plurality of playlists.

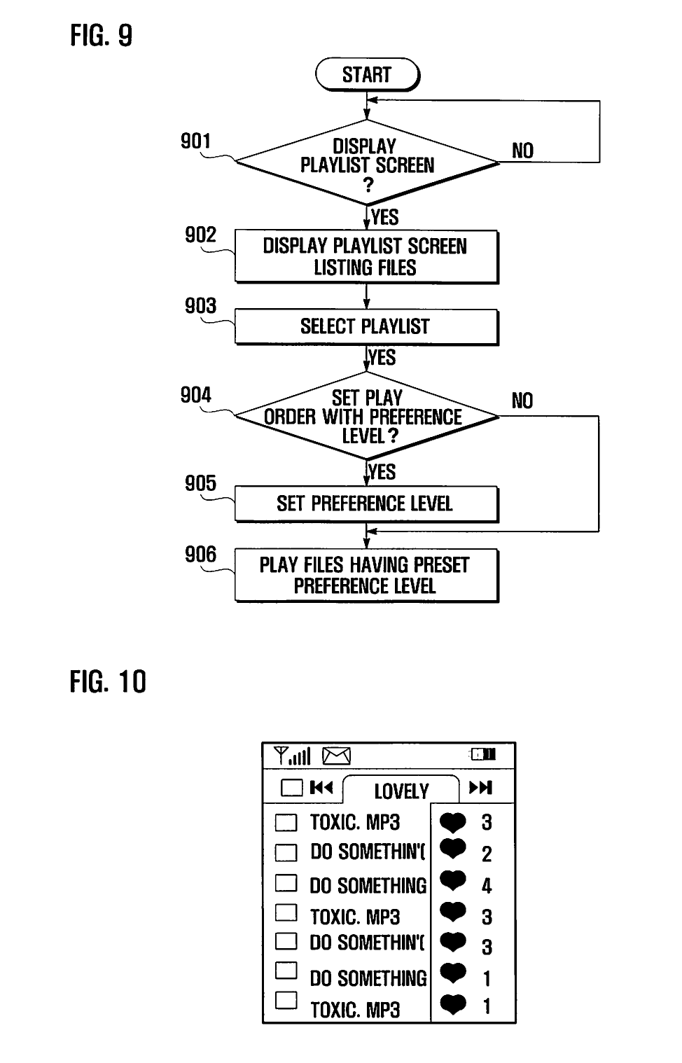

FIG. 9 is a flowchart illustrating a playlist-based file playback procedure of a playlist management method according an exemplary embodiment of the present invention, and FIG. 10 is a screen image illustrating a playlist screen associated with the playlist-based file playback procedure of FIG. 9.

Referring to FIG. 9, in the playlist-based file playback procedure, the mobile terminal determines whether a playlist selection command is input, in step 901. If a playlist selection command is input, the mobile terminal displays a playlist screen listing the files registered to the selected playlist as shown in FIG. 10, in step 902. The currently presented playlist can be changed by manipulating the jog, for example, by moving the jog left or right, in step 903.

After a playlist is selected, the mobile terminal determines whether a play order-setting request command is input, in step 904. If a play order-setting request command is input, the mobile terminal allows the user to set the preference level of the files to be played, in step 905. For example, if the preference level is set to 3, the music files having the preference level 3 are played. After the play order is set, the mobile terminal starts playing the music files registered with the selected preference level 3, in step 906. If there is no play order-setting request command, the mobile terminal plays all the files registered to the playlist, in step 906.

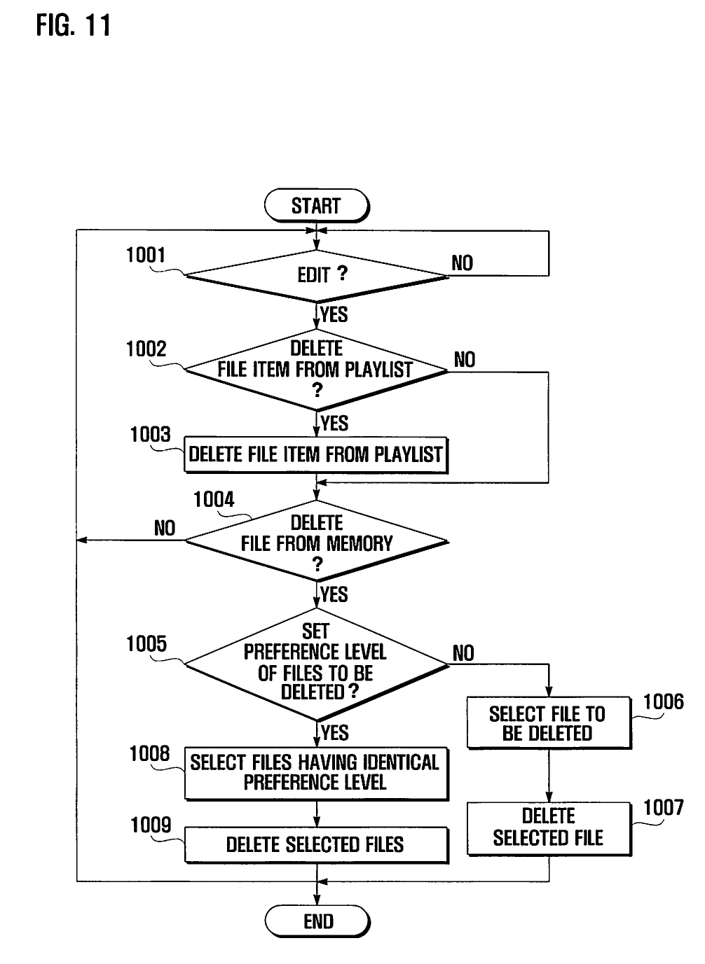

FIG. 11 is a flowchart illustrating a playlist editing procedure of a playlist management method according to an exemplary embodiment of the present invention.

Referring to FIG. 11, the mobile terminal determines whether a playlist editing command is input, in step 1001. If a playlist editing command is input, the mobile terminal determines whether an item delete command is input, in step 1002. If an item delete command is input, the mobile terminal deletes a file item highlighted by a cursor, in step 1003. In this case, only the file item is deleted from the playlist, but the file corresponding to the file item is maintained within the memory unit.

If no delete command is input, the mobile terminal determines whether a file delete command is input, in step 1004. If a file delete command is input, the mobile terminal determines whether a target preference level selection command is input, in step 1005. If the target preference level selection command is input, the mobile terminal selects all the files having the preference levels indicated by the target preference level selection command, in step 1008, and deletes the files file indicated by the target preference level selection command, in step 1009. For example, if the target preference level selection command indicates the preference level 3, all the files of which the preference level is less than and equal to 3 will be deleted from the memory unit.

If no target preference level selection command is input, the mobile terminal determines that the file of which icon is highlighted by a cursor is the target file, in step 1006, and deletes the target file from the memory unit in accordance with a delete command, in step 1007.

Although the playlist management method is implemented with the mobile terminal, the present invention is not limited thereto. For example, the playlist management method of the present invention can be adopted to a Personal Digital Assistant (PDA), a Portable Multimedia Player (PMP), an MP3 player, a digital broadcast receiver, and their equivalents.

As described above, the playlist management method of the present invention enables the user to register a music file to a playlist together with a preference level, thereby improving playlist manageability and user convenience.

Also, the playlist management method of the present invention allows selecting files to be played by at least one of playlist and preference level, whereby the music files to be played are selected in various manners.

Also, the playlist management method of the present invention is advantageous in editing the playlists since the files can be deleted from the playlist or memory and added to the playlist and memory by preference level.

Although exemplary embodiments of the present invention are described in detail hereinabove, it should be clearly understood that many variations and/or modifications of the basic inventive concepts herein taught which may appear to those skilled in the present art will still fall within the spirit and scope of the present invention as defined in the appended claims.

What is claimed is:

1. A playlist management method for a mobile terminal, comprising:
playing a multimedia file; and
editing a playlist in association with the multimedia file during the playback of the multimedia file.

2. The playlist management method of claim 1, wherein editing a playlist comprises assigning a preference level to the multimedia file.

3. The playlist management method of claim 1, wherein editing a playlist comprises:
presenting a plurality of icons;
selecting one of the icons for representing the playlist; and
registering the selected icon as a playlist icon.

4. The playlist management method of claim 1, wherein editing a playlist comprises creating a new playlist.

5. The playlist management method of claim 4, wherein creating a new playlist comprises assigning an icon to the new playlist.

6. The playlist management method of claim 2, wherein the preference level is represented by a corresponding number of icons that symbolize the playlist.

7. The playlist management method of claim 2, wherein editing a playlist comprises determining a play-order of files in the playlist in accordance with the preference levels of the files in the playlist.

8. The playlist management method of claim 2, further comprising storing the file together with information on the playlist and the preference level.

9. The playlist management method of claim 1, wherein the playlist is represented by a playlist icon.

10. The playlist management method of claim 2, further comprising:
displaying the playlist screen on which a plurality playlists are selectively presented:
selecting one of the playlists;
selecting a preference level with which files are to be played; and
playing the files in the playlist assigned the preference level.

11. The playlist management method of claim 2, further comprising:
selecting a preference level with which files are to be deleted; and
deleting the files assigned the preference level in the playlist.
